(19) United States
(12) Patent Application Publication
(10) Pub. No.: US 2024/0160003 A1
(43) Pub. Date: May 16, 2024

(54) MONOLITHIC SPACE TELESCOPES AND MOUNTING SYSTEM

(71) Applicant: Lawrence Livermore National Security, LLC, Livermore, CA (US)

(72) Inventors: Frank Ravizza, Livermore, CA (US); Brian J. Bauman, Livermore, CA (US); Tiffany Yslas, San Lorenzo, CA (US); Lisle B. Hagler, Livermore, CA (US); Amy Wat, Oakland, CA (US); Jonathan Michael Gordon, Elk Grove, CA (US); Michael Yiu-Ming Wong, Livermore, CA (US); Alexander J. Pertica, Livermore, CA (US); Hilary Johnson, Livermore, CA (US); Jordan Smilo, Livermore, CA (US)

(21) Appl. No.: 18/506,920

(22) Filed: Nov. 10, 2023

Related U.S. Application Data
(60) Provisional application No. 63/383,318, filed on Nov. 11, 2022.

(51) Int. Cl. G02B 23/16; G02B 23/02

(52) U.S. Cl. CPC G02B 23/16; G02B 23/02

(57) ABSTRACT

Disclosed are methods and devices related to a radial mounting interface holding a compact monolithic telescope, or generally an optical component, with robust optical alignment. An example optical mounting apparatus includes a mounting structure including a plurality of segments that are configured to surround a circumferential area of a monolithic optical device and to hold the monolithic optical device in place, wherein each of the plurality of segments includes a ridged or a grooved interface surface to couple the mounting structure to corresponding grooves or ridges in a surface of the monolithic optical device. The apparatus further includes an elastomeric material confined between the ridged or grooved interface surface of the mounting structure and the one or more corresponding grooves or ridges in the surface of the monolithic optical device. Also disclosed are thermal management features that passively enable diffraction-limited performance of large aperture monolithic optics.

### CROSS-REFERENCE TO RELATED APPLICATIONS

This patent application claims the benefit of priority of U.S. Provisional Patent Application No. 63/383,318 titled MONOLITHIC SPACE TELESCOPES AND MOUNTING SYSTEM, filed on Nov. 11, 2022. The entire contents of the aforementioned patent application are incorporated by reference in their entirety as part of the disclosure of this application.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### TECHNICAL FIELD

The present disclosure relates to light-weight monolithic optics.

### BACKGROUND

Optical systems for space and airborne applications are subject to significant shock and vibration during flight and even more so during launch. Most optical systems including telescopes are very sensitive to alignment of the optical components. Even if alignment is not an issue, optical components can be damaged during launch because of the forces exerted on those components. New optical systems and mounting techniques for the optical systems are needed that survive launch and maintain alignment after launch and during flight.

### SUMMARY

Embodiments disclosed herein provide a roadmap for low earth orbit (LEO) imaging at a scale that is capable of meeting performance, resiliency, and cost requirements of telescope constellations. Here, the feasibility of constructing large aperture (e.g., 50-cm) monolithic space telescope is disclosed. Monolithic telescopes (or referred to herein as monoliths) permanently align the mirrors within a monolithic substrate. Doing so ensures performance in orbit, and eliminates the need for costly testing and realignment during assembly and integration of the telescope onto the satellite. This benefit along with the monolith's reduced size permits more satellites to be launched per rocket, reducing constellation cost. Smaller aperture monoliths (e.g., up to 18-cm diameter aperture) may not provide useful foreground resolution imagery in the visible spectrum from Low Earth Orbit (LEO). Embodiments disclosed herein include and enable larger aperture monoliths, including sub-meter class, and this requires diffraction-limited telescopes of 50-cm or larger. The present disclosure provides a new approach to optomechanically constrain large aperture monoliths (e.g., 62-kg, 50-cm aperture) within a radial groove using an elastomeric bearing. The disclosed embodiments of optic retention can survive up to the required 60 g launch acceleration. Additionally, passive management of radiative boundary conditions can achieve diffraction-limited performance in orbit under thermal loads. The present disclosure includes embodiments to mitigate thermal gradients that defocus the telescope, and to reduce radiative heat loss that drive these gradients.

Large aperture monoliths are expected to serve in a broad set of imaging missions from space and aircraft. Specifically, large aperture monoliths provide useful ground resolution imagery from LEO because it is sub-meter class in the visible spectrum. Constellations of dozens or more such telescopes can be deployed. Additionally, monolithic telescopes of large aperture class can be used to detect Earth-size exoplanets and study the nature of black holes and dark matter through time domain astronomy (microlensing surveys) which require large light collection apertures and a wide field of view.

In one aspect, an optical mounting apparatus is disclosed. The apparatus includes a mounting structure including a plurality of segments that are configured to surround a circumferential area of a monolithic optical device and to hold the monolithic optical device in place, wherein each of the plurality of segments includes a ridged or a grooved interface surface to couple the mounting structure to one or more corresponding grooves or ridges in a surface of the monolithic optical device. The apparatus further includes an elastomeric material confined between the ridged or grooved interface surface of the mounting structure and the one or more corresponding grooves or ridges in the surface of the monolithic optical device.

The following features can be included in various combinations. The mounting structure excludes flanges or sections that protrude beyond the circumferential area of a monolithic optical device. Each of the plurality of segments includes two or more ridges having a first elliptical shape that are configured to interface with two or more corresponding grooves in the surface of the monolithic optical device having a second elliptical shape. The first elliptical shape and the second elliptical shape are the same elliptical shape. Each of the plurality of segments includes two or more ridges having a first sinusoidal shape that are configured to interface with two or more corresponding grooves in the surface of the monolithic optical device having a second sinusoidal shape. Each of the plurality of segments includes two or more ridges having a first square or rectangular shape that are configured to interface with two or more corresponding grooves in the surface of the monolithic optical device having a second square or rectangular shape. The plurality of segments include between two and eight segments. The plurality of segments are held together with bolts that after tightening provide a predetermined pre-load compression force on the monolithic optical device. The apparatus further includes a plurality of vibration isolators coupled to the mounting structure and configured to isolate the mounting structure and the monolithic optical device from vibrations associated another component. The optical mounting apparatus comprises a carbon fiber composite material. The optical mounting apparatus is configured to exert 100 to 300 pounds of compression force on the monolithic optical device. The monolithic optical device is configured to hold in place the monolithic optical device that has a 50 cm diameter. The optical mounting apparatus is cylindrically symmetric, and the ridged or grooved interface surfaces of the plurality of segments of the mounting structure are configured to allow a uniformly distributed preload pressure to be applied onto the monolithic optical device. The ridged or grooved interface surfaces of the plurality of segments of the mounting structure when mated with the one or more corresponding grooves or ridges in the surface of the monolithic optical device produce a stable configuration that allows launch of an optical system that includes the optical mounting apparatus and the monolithic optical device in any launch orientation into outer space. The ridged or grooved interface surfaces of the plurality of segments of the mounting structure includes a single groove or ridge configured to interface with a corresponding single ridge or groove in the surface of the monolithic optical device, and wherein a location of the ridge or groove is selected to be aligned with a center of mass of the monolithic optical device. The elastomeric material is positioned to cover the entire circumferential area of the monolithic optical device that is confined within the plurality of segments of the mounting structure. The monolithic optical device is part of a spaceborne Cassegrain telescope. The elastomeric material comprises Viton or another fluoroelastomer material.

In another aspect a method of mounting a monolithic optical device is disclosed. The method includes holding in position, by a mounting structure, the monolithic optical device, and coupling the mounting structure to the monolithic optical device via a ridged or grooved interface surface on the mounting structure structured to couple to corresponding grooves or ridges in a surface of the monolithic optical device. The method further includes confining an elastomeric material between the ridged or grooved interface surface of the mounting structure and the corresponding grooves or ridges in the surface of the monolithic optical device.

The following features can be included in various combinations. The method includes coupling a plurality of vibration isolators to the mounting structure configured to isolate vibration from a spacecraft from the mounting structure and monolithic optical device. The ridges of ridged interface surface of the mounting structure have a first elliptical shape, and wherein the compatible grooves in the surface of the monolithic optical device have a second elliptical shape.

### BRIEF DESCRIPTION OF THE DRAWINGS

FIG. 1 depicts a first example of a Cassegrain telescope made using monolithic optical technology.

FIGS. 2A-2D depict cross-sectional examples of mounting interfaces between a monolithic optical device and a mounting structure.

FIG. 3 shows some features of the disclosed monolithic optical systems with the groove and ridge mounting interface compared to a traditional Cassegrain approach.

FIG. 4 shows an example of mounting structure including multiple sections that can be combined to complete a mounting structure for a monolithic optical device.

FIGS. 5A-5B show examples of mounting structures for holding a monolithic optical device.

FIG. 6 shows an example of a vibration profile of frequency vs. power spectral density in (g²/Hz) for some space launch applications.

FIG. 7 shows some example analysis showing an effective modulus of a confined elastomeric material such as an elastomeric material confined between the grooves in a monolithic optical device and the ridges in the mounting structure.

FIG. 8 shows an example of a method of mounting a monolithic optical device.

FIG. 9 shows a table with example values for optical properties used in an example optical system implemented in accordance with the disclosed technology.

FIG. 10 shows renderings of an example optical system implemented in accordance with the disclosed technology.

FIG. 11 describes the sensitivity of temperature driven spatial dependent terms.

FIGS. 12A-12B illustrate thermal gradients for an optical system in three variations of passive optothermal management.

FIG. 13 illustrates thermal gradients for an optical system in three variations of passive optothermal management.

FIGS. 14A-14B demonstrate simulated effects of an IR reflective window for passive optothermal management.

FIG. 15 illustrates an evolution of monolithic optical system or structure design to improve thermal homogeneity.

FIG. 16 illustrates an evolution of monolithic optical system or structure design to improve thermal homogeneity.

FIG. 17 illustrates an evolution of monolithic optical system or structure design to improve thermal homogeneity.

### DETAILED DESCRIPTION

Disclosed embodiments include methods and devices related to a radial mounting interface holding a compact monolithic telescope (or generally an optical component) with robust optical alignment. Example telescopes have various diameters from about 25 cm up to about 50 cm or larger. One example telescope described herein has a wide field of view, a fast focal aperture ratio, and excellent image quality. The example telescope includes an aspheric refractive surface and a planar corrector surface to correct for spherical and comatic aberrations. The term “monolithic” means that the optical system is fabricated from a single block of optical material (e.g., glass, or other material). The radial mounting interface holds the monolithic optical component in place via ridges in a mounting structure that interface with grooves in the monolithic optical component. An elastomeric material sandwiched and confined between the grooves and ridges provides mechanical compliance. The grooves, ridges, and elastomeric material minimize mounting pressure on the monolithic telescope and minimize the shock and vibration loads when the monolithic optical system is deployed in extreme environments such as that experienced on aircraft or spacecraft. The disclosed embodiments have important advantages over more conventional systems including improved strength and alignment robustness, and reduced stresses on the monolithic components thereby reducing mechanical failures during launch and spaceflight.

One aspect of the disclosed embodiments relates to a radial mounting interface that includes grooves running along the circumference of the cylindrical outer wall of the monolithic telescope. The grooves interface with ridges running along the inner circumference of a mounting structure such that the grooved surface mates to the ridges in the mounting structure to hold the monolithic telescope in place. An elastomeric material is disposed between the ridges and the grooves and confined by the ridges and grooves and can provide some compliant movement under shock and vibration loads. Elastomeric materials include Viton™, another fluoroelastomeric, or an elastomeric material that is suitable, for example, for temperature, vacuum, and radiation associated with the space environment. The grooves can have various shapes such as square or rectangular grooves, sinusoidally shaped grooves, elliptical grooves, cylindrical grooves, and other shapes. The ridges on the mounting structure can have the “inverse” shape. For example, for square or rectangular grooves, the ridges may also have a square or rectangular shape, for elliptically shaped grooves, the ridges may also have an elliptical shape that mates with the shape of the grooves. In some example embodiments, the ridges and grooves can have different shapes. For example, the groove can have one elliptical shape and the ridges could have a different elliptical shape, or a different size.

Described next are some of the features of a monolithic telescope that incorporates the foregoing mounting structure. Monolithic telescopes have many advantages as will be apparent for the following description. Earlier approaches to compact long focal length two-minor Cassegrain type telescopes use aggressively curved (short radii of curvature) mirrors. However, such aggressively curved minors require alignment that is extremely high precision (less than 10 micrometer displacement errors). Engineering and manufacturing optomechanical structures to maintain such high precision alignment in a small size and mass package that also survives rocket acceleration during space launch is very difficult and costly. Meeting these requirements results in a high cost of manufacturing and a poor economy of scale when high volume production is required due the need to realign elements on the ground prior to launch or even while in orbit.

Monolithic telescopes simplify the optomechanical challenges of mechanical strength, stability, and optical alignment thereby making conventional optomechanical structures obsolete. Monolithic telescopes, such as a two-minor Cassegrain telescope, have the two minors fabricated from a single substrate including a single monolithic block of transparent optical material. Such designs are small and tend to be immune to change in alignment due to the acceleration of space launch. Earlier monolithic telescope designs have worked well for long focal lengths and high f-number telescopes but tended to have reduced image quality at a wide field of view (short focal lengths) or at fast focal ratios (low f-numbers), and when both short focal lengths and a low f-number are needed.

The disclosed monolithic telescopes achieve both a wide field of view and fast f-number within a monolithic substrate by incorporating an aspheric convex refractive first surface and a planar aspheric field corrector surface as the final refractive surface. These two refractive surfaces work in conjunction with a concave aspheric primary mirror and convex aspheric secondary mirror (e.g., Cassegrain telescope) to improve high-order off-axis aberration correction (e.g., coma, astigmatism) thereby permitting wider fields of view and at faster f-numbers. The foregoing additional refractive surfaces are fabricated into the monolithic substrate.

To further illustrate the features of the disclosed embodiments, telescopes and space-based optical systems including mounting structures are used throughout this patent document as examples to facilitate the understanding of the disclosed technology. However, applications for the disclosed techniques span beyond space-based telescopes, ground-based telescopes, or astronomy equipment, and include beam directors for lasers, consumer imaging devices, and other applications where alignment stability and aberration correction are important.

Monolithic telescopes generally refer to reflective telescopes fabricated using a single silica substrate. This approach provides exceptional mechanical stability because the relative position of the minors is permanently polished into the monolithic substrate and are inherently temperature insensitive due to the low coefficient of thermal expansion (CTE) of fused silica (0.5 ppm/K). Once fabricated, monolithic telescopes are mechanically robust and reliable because the mirrors will always be aligned, even after subject to extreme force like during a launch into space.

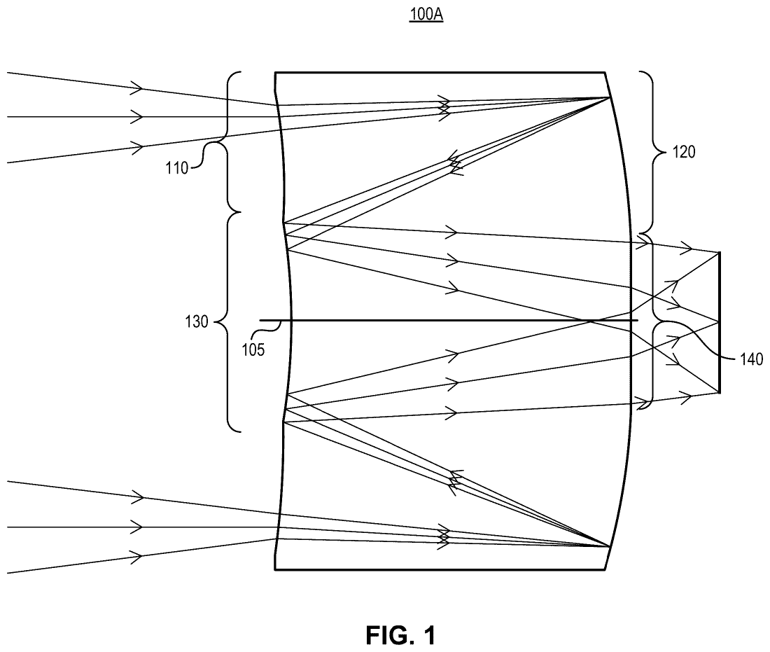

FIG. 1 depicts an example of a monolithic Cassegrain telescope including aspheric first and second refractive surfaces and mirrors made using monolithic optical technology. FIG. 1 shows a cross-sectional view of a telescope 100A. Telescope 100A is circularly symmetric about axis 105 and includes a first refractive surface 110, first reflective surface 120, a second reflective surface 130, and second refractive surface 140. The first refractive surface 110, first reflective surface 120, second reflective surface 130, and second refractive surface 140 may each be produced according to a different prescription. Each prescription can be described by a different mathematical polynomial that specifies the shape of the corresponding surface.

Example Mounting Interfaces and Optomechanical Features

Monolithic optical devices are used as examples to facilitate the illustration of the disclosed technology. Some aspects of the present disclosure relate to optomechanical features for overcoming technical challenges related to large aperture monolithic optical devices. To constrain a large scale optic, example embodiments disclosed herein employ radial concave grooves with various cross-sectional geometries cut into the outer cylinder of the monolith. These grooves interlock matching conforming convex features on the interior of a mounting ring that are used to compress the outer cylinder of the monolith between an elastomeric bearing. In some embodiments, this mounting ring is constructed from a high specific strength carbon composite with a low coefficient of thermal expansion (CTE). Radial groove mounting according to the disclosed embodiments places minimal mounting pressure on the monolithic optical component (generally, optical component or optic), thus avoiding excessive mounting pressures that can cause catastrophic optic failure due to fracture initiation and growth under launch acceleration. Additionally, in some embodiments, the optic is affixed within a suspension system, thus reducing the dynamic load on the optic. The suspension can be configured to a set static preload compressing the optic. A suspension system typically would not be permissible for conventional telescopes due to the requirement to hold the primary and the secondary mirrors in alignment. However, monolithic optical devices do not have this requirement. In some embodiments, to further reduce acceleration forces on the optic, vibration isolators are used to attenuate high frequency vibrational loads on the optic, which can reduce the overall root-mean-square (RMS) load by, for example, 3×.

Scaling up to larger scale monolithic optical devices presents several technical challenges, including monolith mass which scales with the aperture diameter cubed (assuming the optical design form in constant with aperture). For example, a 50-cm class aperture system therefore is expected to exceeded 62-kg for the glass alone. During launch, this mass can be subject to 60 g of acceleration, resulting in 36 kN of force (˜8000 lbf) on the glass. Constraining this force within a housing is challenging due to limits on mounting pressure applied to the glass. Pressures in excess of the glass fracture toughness can break the optic. Force applied along the optical axis (z-axis) requires mounting pressure on the outer perimeter of the optic's plano face and this carries increased risk of fracture. Additionally, the area available for mounting should be narrow to avoid obscuring the telescope's clear aperture. Increasing the mechanical diameter of the optic to accommodate increased mounting area on the plano face is undesirable because it also increases the size and mass of the optic. Therefore, in practice, the outer diameter mounting area is limited to a narrow strip around on the order of 5% of the optic mechanical diameter, or 12.5 mm wide band around the plano face of 50-cm aperture—a surface area of just 0.02 m². To constrain the 62 kg half-meter monolith mass under a 60 g launch requires a preload force of 36 kN and this produces a static pressure of 1.6 MPa on the brittle edge of the glass. This mounting pressure exceeds the fracture toughness of fused silica, reported in literature at −0.5 MPa. During launch, dynamic pressure will exceed this static pressure by an even greater magnitude. Therefore, catastrophic failure is probable under this mounting approach.

Rigid optic constraint applies preload in all degrees of freedom of motion (XYZ-directions, plus roll, pitch, and yaw). Besides risk of catastrophic failure (e.g., facture), pressure on the monolith optic introduces stress in the glass causing localized change in the index of refraction proportional to the induced stress. Changes in index of refraction leads to optical path difference (OPD) and a defocused optic. Analysis of the OPD induced stress shows that peak stress difference should be beheld to less than 0.5 MPa. This result informed the mounting approaches disclosed herein, which can reduce mounting pressure by increasing mounting area and/or reducing applied force (pre-load). It also suggested rigid mounting should be avoided. Existing space telescope mounting approaches are required to be rigid to hold minors in a fixed position relative to one another. For monoliths, this requirement can be relaxed.

The housing concept developed for a large scale monolith utilizes a new surface geometry interface integrated into the outer cylinder of the optic that includes a plurality of grooves ground into its outer cylinder centered on its center of mass. This housing assembles around the optic cylinder as a ring in a plurality of radial segments and features protruding (e.g., convex) radial ridges on its interior surface that conform to or correspond to the monolith grooves. The ring housing compresses the monolith between a thin elastomeric material to a set static preload thereby kinematically constraining the telescope in all six degrees of freedom while serving as a suspension system under dynamic acceleration while providing accommodation of thermal expansion mismatch. Unlike conventional telescopes, which require high-precision mirror alignment, monoliths are tolerant to a relatively large magnitudes of dynamic motion during launch.

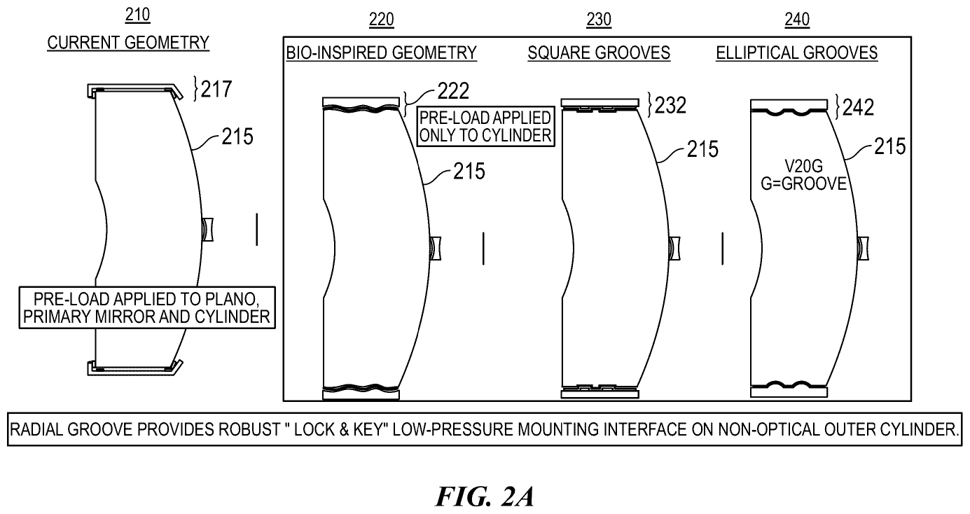

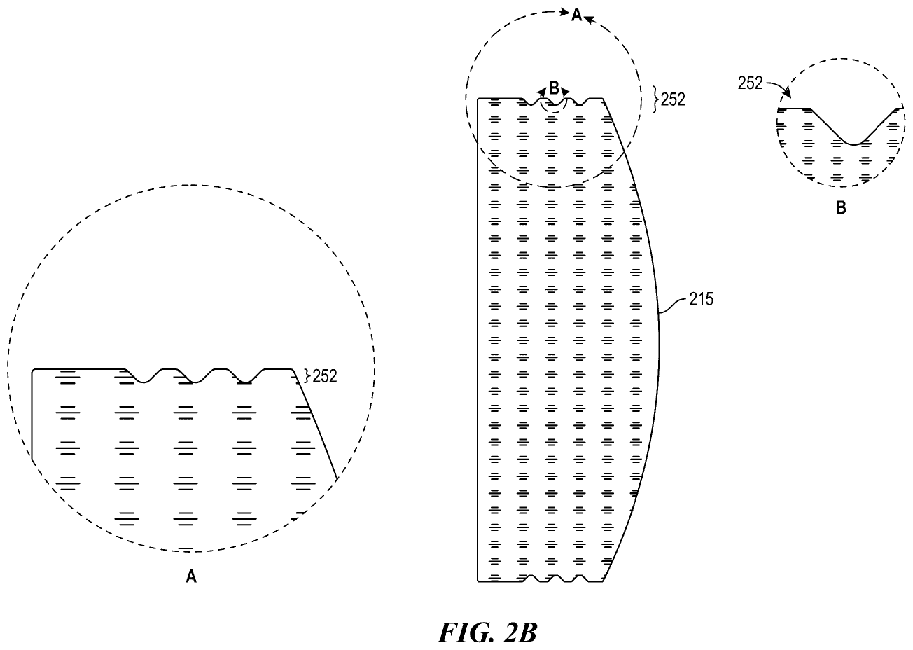

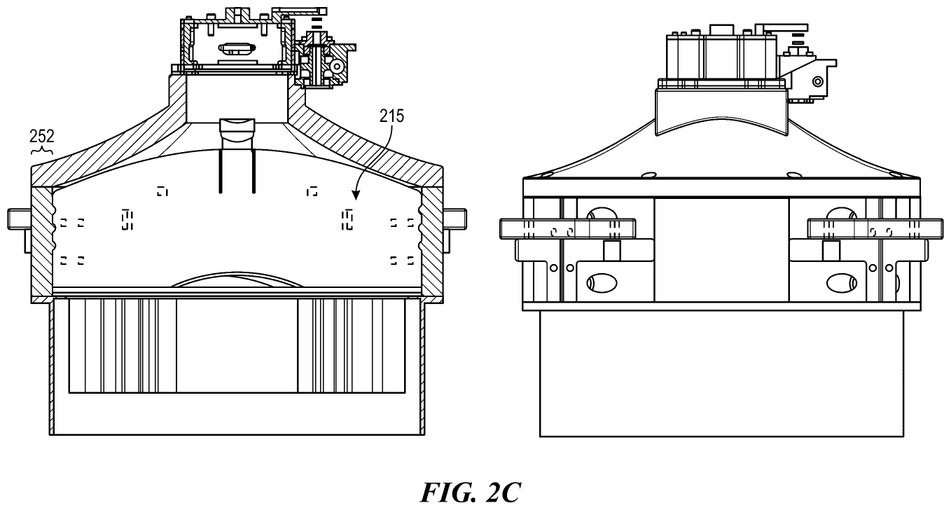

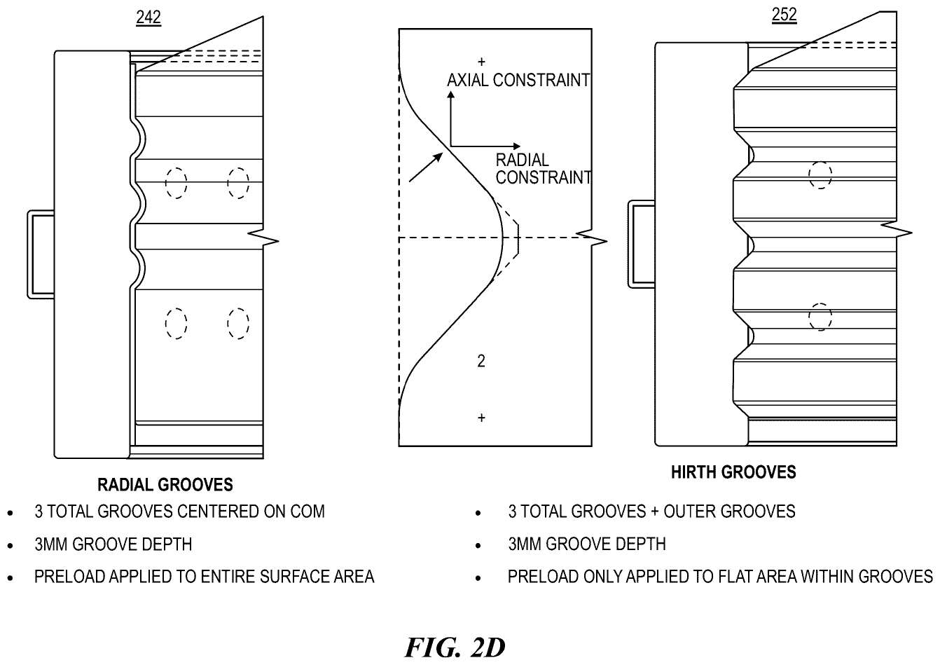

FIG. 2A depicts cross-sectional views of an existing mounting interface and various embodiments of mounting interfaces consistent with the disclosed subject matter. Both the existing mounting interface and the disclosed embodiments are interfaces between a monolithic optical device (e.g., a monolithic telescope) and a mounting structure. At 210, mounting bracket 217 is used to mount monolithic optical component 215 to a larger system or structure (not shown). Mounting bracket 217 includes flanges on both sides of the mounting bracket 217 that hold in place the monolithic optical component 215. In the example at 210, the left-side square edge of the monolithic optical component 215 is captured by a right-angle flange and the right-side angled edge due to the convex shape of the monolithic optical component 215 is captured by an angled flange. An elastomeric material may be positioned at certain contact locations between the monolithic optical structure and the flanges of the mounting structure. During assembly of the optical system and prior to launch, the mounting bracket 217 is positioned around the monolithic optical component 215 and a static preload mounting pressure is applied to hold the structure in place.

The configuration at 210, however, has several shortcomings. For example, excessive force can be exerted onto the monolithic optical component 215 at the edges of the mounting bracket 217, which can result in damage to the monolithic optical component and/or in stress-induced change in refractive index of the monolithic optical component. According to Fermat's principle of least time, two dynamic terms contribute to optical path length differences in a material that cause reduction in optical image quality. These two terms include a temperature dependent term and a stress dependent term. Accordingly, temperature differences can cause image aberrations as can stresses on the optical materials such as mounting stresses due to a mounting structure. Due in-part to these limitations, the weight of the optical component (payload) is often limited (e.g., to less than 30 kg) and the launch orientation is often limited to a particular range. These and other shortcomings are alleviated using the mounting interfaces that are disclosed herein.

In accordance with an example embodiment, at 220 the mounting interface 222 is used to mount monolithic optical device component to the larger system or structure. Mounting interface 222 includes sinusoidal ridges in the mounting structure that engage with sinusoidal grooves in the monolithic optical component 215. An elastomeric material is positioned between the sinusoidal grooves in the monolithic optical structure and the sinusoidal ridges of the mounting structure. The elastomeric material covers the entire surface of the mounting structure and operates to reduce the stress or pressure exerted onto the monolithic optical device, and to dampen vibration. The elastomeric material is confined between the grooves and ridges and cannot move into any other space other than between the grooves and ridges (i.e., the elastomeric material cannot “ooze” out from between the ridges and grooves).

As indicated, the sinusoidal geometry for the mounting interface 222 is bio-inspired. This housing configuration takes inspiration from a suture approach. Bone plate boundaries in human skulls and hips share a similar cartilage separated quasi-sinusoidal mating geometry, hence we refer to this configuration as bio-inspired. Knee joints are analogous here, where cartilage separates upper and lower leg bones while ligaments kinematically constrains their relative alignment.

At 230, another example embodiment is illustrated in which mounting interface 232 is used to mount monolithic optical component 215 to the larger system or structure. Mounting interface 232 includes square ridges in the mounting structure that engage square grooves in the monolithic optical component 215. Elastomeric material is placed between the square grooves in the monolithic optical structure and the square ridges of the mounting structure.

At 240, another example embodiment is illustrated in which mounting interface 242 is used to mount monolithic optical component 215 to the larger system or structure. Mounting interface 242 includes elliptical ridges in the mounting structure that interface with elliptical grooves in the monolithic optical component 215. Elastomeric material is placed between the elliptical grooves in the monolithic optical structure and the elliptical ridges of the mounting structure.

Notably, in the mounting interface examples at 220, 230, and 240 the angled flanges associated with mounting bracket 217 are not present, which alleviates the issues with directional stress and pressure during launch and allows for an arbitrary launch direction. In the sections that follow, the example mounting interface configuration at 240 was used to conduct various tests and simulations.

FIGS. 2B-2D depict example embodiments of a mounting interface 252 between a monolithic optical device (e.g., a monolithic telescope) and a mounting structure, referred to as a radial Hirth groove. The mounting interface 252 includes “Hirth” ridges or protrusions (e.g., trapezoidal, triangular, angled, etc.) in the mounting structure that interface with correspondingly-shaped grooves in the monolithic optical component 215. In some embodiments, the Hirth cross-sectional geometry is based on a 90-degree geometry with rounded angles. FIG. 2D shows a comparison between the mounting interface 252 with a Hirth cross-sectional geometry with the mounting interface 242 with an elliptical geometry. The Hirth cross-sectional geometry includes planar (flat) contact surfaces within a triangular, trapezoidal, etc. shape. Accordingly, an outer mounting ring compresses the optic primarily on the flat surfaces of the Hirth geometry to maintain positional tolerance between ring and optic structure post dynamic loading event via increased pressure, moderate-to-high stiffness within this interface but below pressure and stress which exceeds glass fracture toughness.

These mounting approaches provide means of mechanically coupling the optic to an optomechanical interface for affixing to the end-use platform such as a space satellite. A ring-like clamp is radially compressed on the outer cylinder with a matching grooves which locks the optic in place. An elastomeric membrane (e.g., Viton) may be incorporated between the ring and the optic to provide several benefits as described below. The purpose of the example embodiments of mounting interfaces described herein is enhanced positional stability post dynamic loads (e.g. rocket launch) via quasi elastic averaging to kinematic interfacing with the following benefits:
1) Low mounting stress and pressure on the glass optic.
2) Tolerance to high-to-extreme acceleration loading (>100 g peak-to-peak).
3) Quasi-kinematic positional repeatability of the optic position relative to the clamp and dynamic loading events (rocket launch) via elastic averaging.
4) The elastomeric membrane between optic and structure provides a means to compensate for fabrication dimension mismatch between the optic and ring structure to provide uniform compression of the ring onto the optic cylinder thus maintaining homogeneous pressure.
5) The elastomeric membrane provides compliance and vibration dampening under dynamic loads.
6) Reversibility—an optical device can be secured without adhesives, and the optic and the structure can be detached from one another for repeated use.

Note that in the foregoing description, “grooves” describe material removed from the around the circumference of the monolithic optical device to form a shape. In the foregoing description “ridges” describe a material extension protruding from the mounting structure around the circumference of the mounting structure to form a shape that mates with the grooves of the monolithic optical device. It should be noted that in some embodiments, the optical component may be configured to include ridges and the mounting structure may be configured to include grooves that mate with the ridges. In some embodiments, the optical component can have both grooves and ridges that interface with corresponding ridges and grooves of the mounting structure. Additionally, the number of grooves and ridges can be selected to meet the various system requirements. For example, in some embodiments, three grooves and associated ridges are implemented. In some embodiments, a single groove-ridge mounting configuration may be used. In this embodiment, the single ridge/groove location is selected to be aligned with the center of mass of the optical component, or the ridge/groove lies in a plane of symmetry of the optical component that includes the center of mass. Doing so, reduces the moment of inertia of the assembly, and therefore mitigates rocking modes and related forces on the assembly.

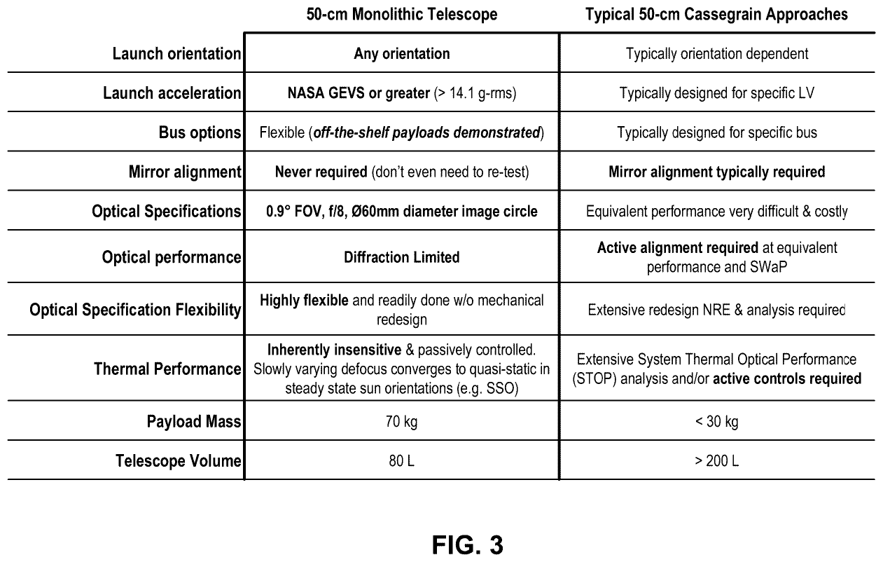

FIG. 3 shows some features of the disclosed monolithic optical systems with the groove and ridge mounting interface compared to a traditional Cassegrain approach. The disclosed monolithic optical systems have many advantages including providing a robust mounting for a monolithic optical device under severe shock and vibration loads.

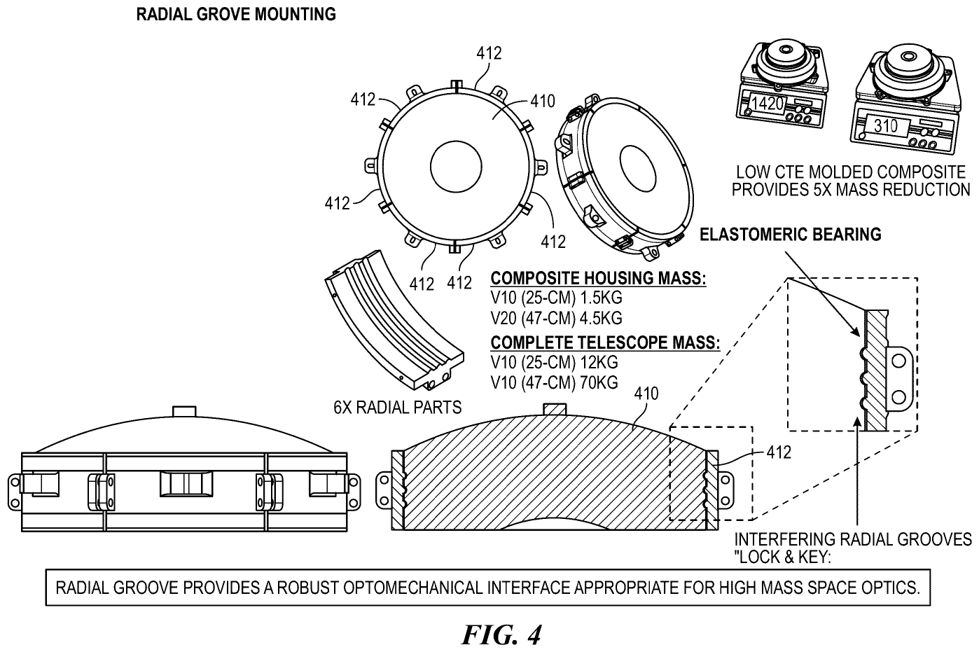

FIG. 4 shows an example of mounting structure including multiple sections that can be combined to complete a mounting structure for a monolithic optical device 410. The example shown in FIG. 4 has six identical sections 412 that when combined together form a mounting structure that compress the outer cylinder of the monolithic optical device 410 to a predetermined compression preload (e.g., 200 lbs). In the depicted example, each section 412 includes flanges with holes to allow the sections to be connected together and tightened via nuts and bolts (not shown). Although the example of FIG. 4 has six sections, any other number of sections greater than two can be used. The multi-section mounting structure can be designed to provide different preload compression values. Ridges in the mounting structure sections and grooves in the monolithic optical device constrain the monolithic optical device in all directions. An elastomeric material between the ridges of the mounting structure and the grooves in the monolithic optical device provides some compliance for movement, mechanical tolerance, and thermal expansion/contraction of both the monolithic optical device and mounting structure. The example mounting structure in FIG. 4 can be produced using composite materials including molded composites that provide a 5× mass reduction compared to aluminum. Both composite materials and metal provide high thermal conductivity. Noted in FIG. 4 are the masses of a mounting structure for 25 cm and 47 cm monolithic telescopes.

FIG. 4 shows six identical radial parts that compress the outer cylinder of the monolith to set a pre-load (e.g., ˜200 lbf). Three matched radial grooves with elliptical profiles in the monolith cylinder and housing provide mechanical interference and constrain telescope motion in all degrees of freedom. An elastomeric material (also referred to herein as an elastomeric bearing material) provides compliance to motion, mechanical tolerance, and thermal expansion. Molded composite (with density: 1.6 g/cc) combines advanced carbon fiber layups in nanotube doped resin with exceptional strength. Fibers oriented along circumference provide matched CTE to silica monolith. Composite has high thermal conductivity helping to present desirable homogenous boundary condition to monolith. Vibration isolators can be attached between the mounting structure and the larger structure of the vehicle.

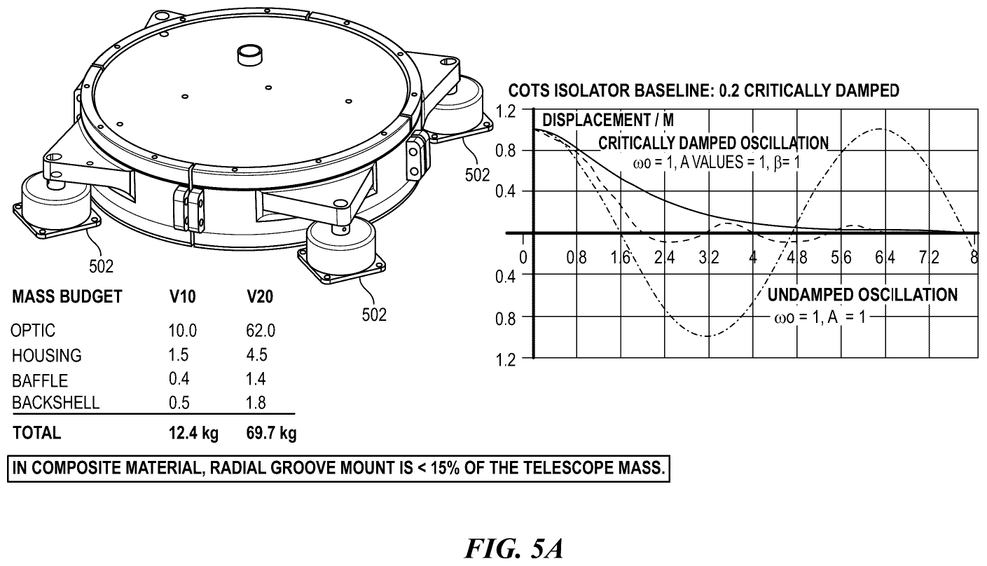

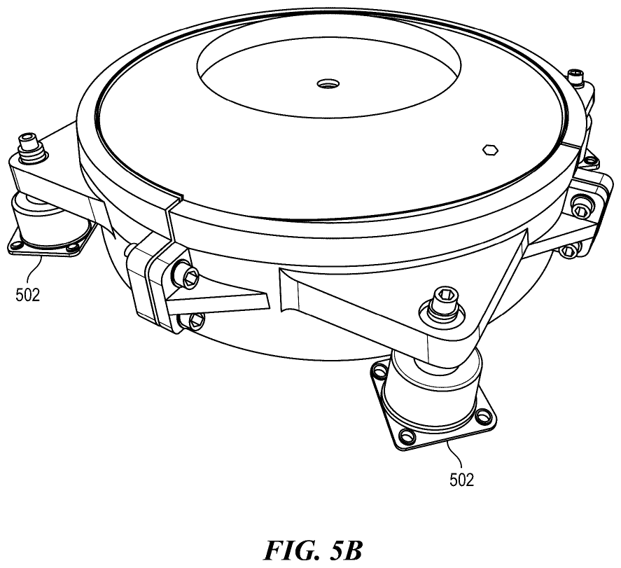

FIG. 5A shows an example mounting structure similar to the example in FIG. 4 that has been assembled together holding a monolithic optical device. The mounting structure in FIG. 5A is attached to vibration isolators 502 which provide critical dampening over a predetermined frequency range that is selected at a design time of the mounting structure. FIG. 5B also depicts vibration isolators 502. These vibration isolators 502 isolate the monolithic optical device from vibrations associated with other components in the system (e.g., the space vehicle). The assembled system in FIG. 5A includes the monolithic optical component and the housing bracket, as well as a baffle and a backshell (not shown). FIG. 5A also shows a table of weights in kilograms of a system with a 25 cm monolithic telescope and 47 cm monolithic telescope. Also shown in FIG. 5A is a plot of the frequency response of a vibration isolator showing displacement as a function of time and undamped, damped, and critically damped responses.

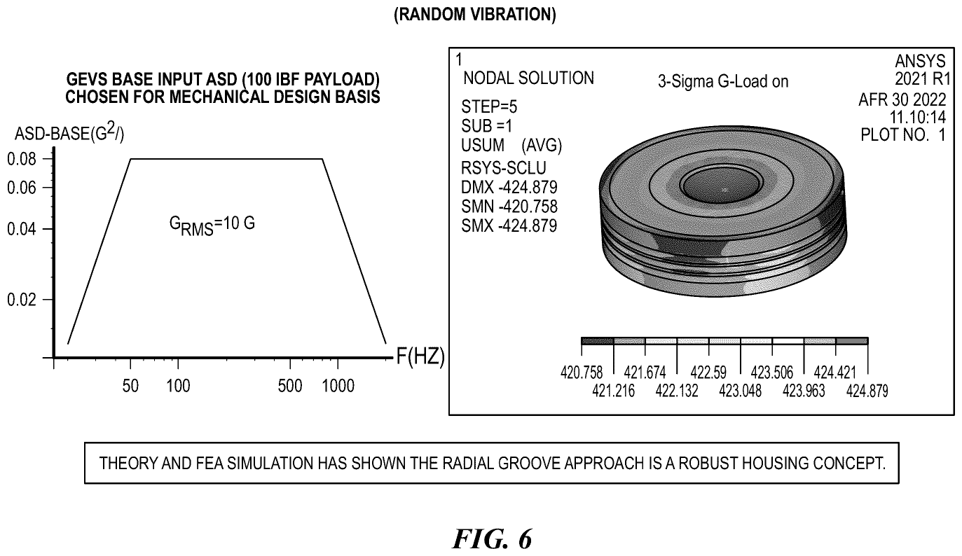

FIG. 6 shows an example of a vibration profile of frequency vs. power spectral density in (g²/Hz) for some space launch applications. The mounting approaches disclosed herein provide large surface areas that minimize the required static preload on the monolith optic, particularly on its sensitive plano and primary mirror faces, to below a threshold where internal stress in the monolithic body of the optic (e.g., fused silica) can induce optical performance degradation caused by localized index of refraction change via dnda (stress analog of dndT). The mounting approaches disclosed herein mitigate gravity induced stress wavefront errors. The vibration profile of FIG. 6 is generated from an FEA simulation of a 50-cm monolith under a 10 g RMS NASA General Environmental Standard test, typically referred to as GEVS. The left-hand plot shows the acceleration spectral density (ASD), which is the frequency spectrum magnitude of acceleration in units of g²/Hz. This ASD spectrum is intended to capture a broad spectrum of launch loads across a wide family of launch vehicles as a strict (difficult to meet) acceleration loading for space hardware, particularly for precision instruments like space telescopes. Simulation tools such as ANSYS mechanical can be used to simulate this load. Random vibration is often the most structurally challenging launch environment. General environmental verification standard (GEVS) is used for a conservative bound when the precise launch vehicle payload acceleration spectral density (ASD) is not yet known.

The right-hand figure shows the 3-sigma G-load on the optic when “hard mounted” to a structure. In the center of the optic, FEA predicts 43 g acceleration (3-sigma) (or 424 m/s²), which corresponds to a net force on the optic of over 5900 lbf. This force greatly increases the risk of elastomer slippage and permanent optic tilt occurring during launch. Vibration isolators can provide significant reduction of the transmitted random vibration load to an acceptable level so as to not cause elastomer slippage or permanent tilt of the optical device. Of note here is the radial ring constraint is designed to apply just 100 lbf of radial compression. Under 10 g RMS GEVS loading, the optic floats free around with the ring well below the stress/strain fracture toughness threshold for fused silica which indicates that the design is highly robust.

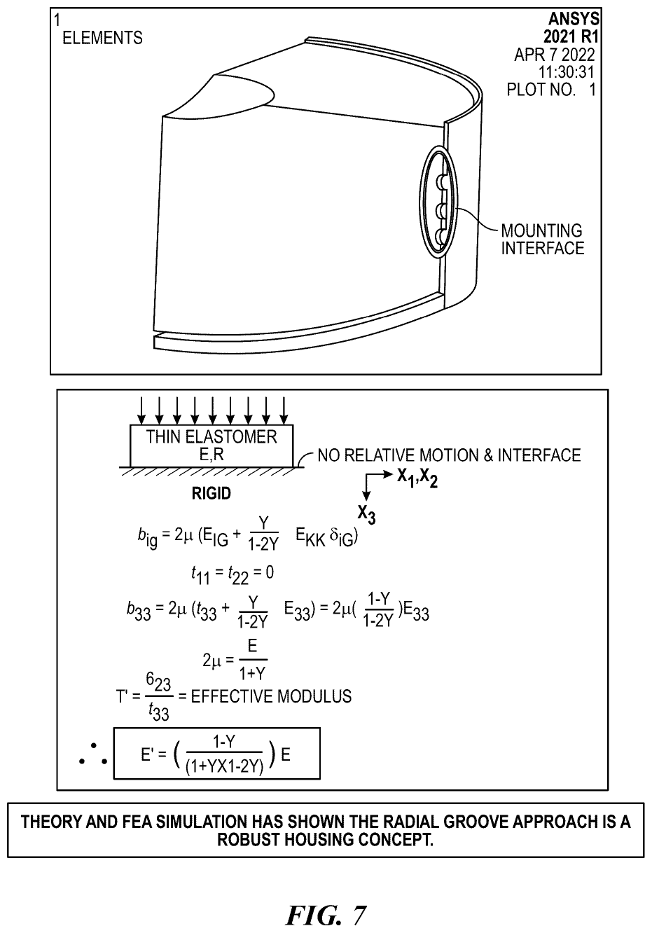

FIG. 7 shows some example analysis showing an effective modulus of a confined elastomeric material such as an elastomeric material confined between the grooves in a monolithic optical device and the ridges in the mounting structure. The analysis shows that when the elastomeric material is suitably confined (no slippage) and subject to tension or compression, the effective Young's Modulus (E′) of the material can be orders of magnitude greater than the unconfined modulus which allows for a very stiff connection between the monolithic optical device and the mounting structure. This allows for pre-load and launch loads to be spread over a large surface area. Many elastomers have a Poisson's Ratio (v) of close to 0.5 which means that when suitably confined (no slippage) and subject to tension or compression, the effective Young's Modulus (E′) of the material can be orders of magnitude greater than the unconfined modulus. This allows for a very stiff connection between the optic and its housing while, at the same time, allowing pre-loads and launch loads to be spread over a large surface area. The disclosed mounting techniques take advantage of this. A thin sheet of elastomer is confined between monolithic optical device and the mounting structure.

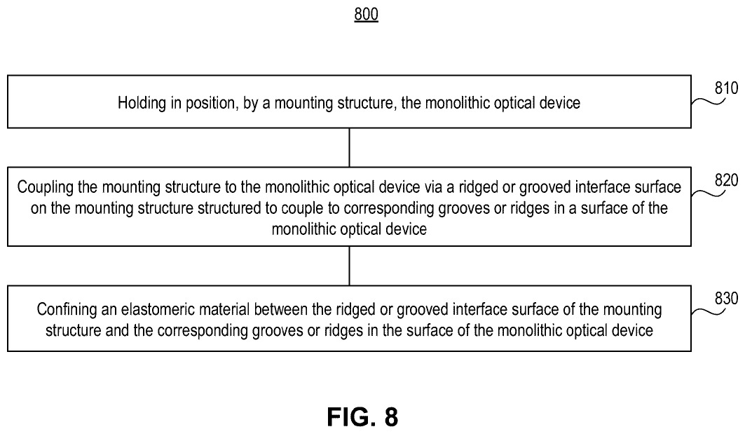

FIG. 8 shows an example of a method 800 of mounting a monolithic optical device. At 810, the method includes holding in position, by a mounting structure, the monolithic optical device. At 820, the method includes coupling the mounting structure to the monolithic optical device via a ridged interface surface on the mounting structure structured to couple to compatible grooves in a surface of the monolithic optical device. At 830, the method includes confining an elastomeric material between the ridged interface surface of the mounting structure and the compatible grooves in the surface of the monolithic optical device.

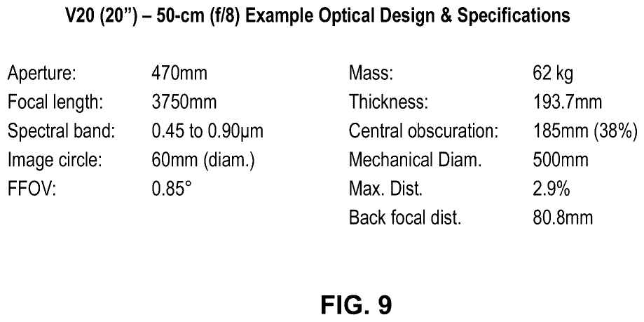

FIG. 9 shows example values for optical properties used in an embodiment of a catadioptric system and used in a simulation of the example embodiment. The values shown are for example values presented for illustration purposes. Other example systems incorporating the disclosed subject matter will have different values dependent on the design goals and optimization performed.

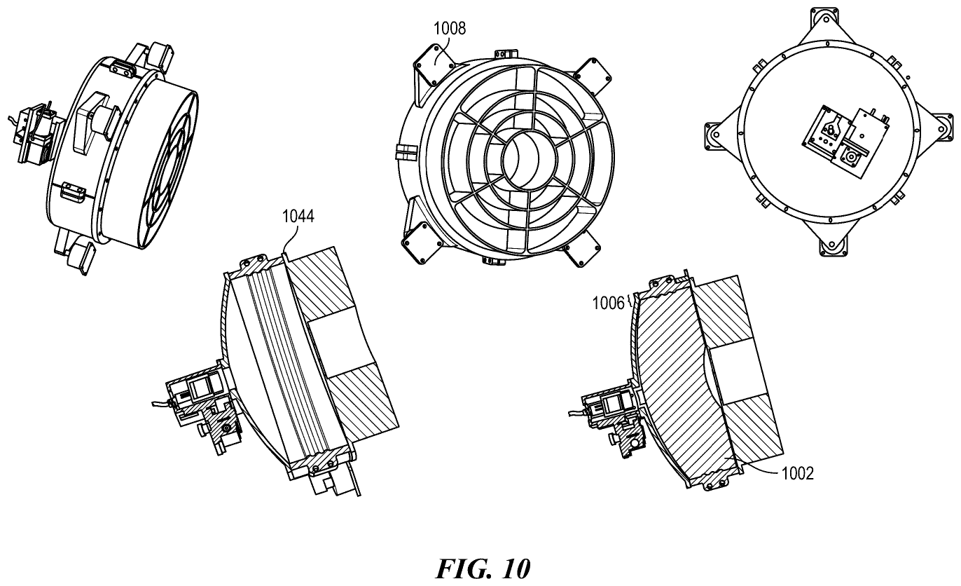

FIG. 10 shows example renderings of a system including a monolithic optical device 1002 mounted within a mounting structure 1004. The mounting structure 1004 can include one or more radial ridges (ridges spanning along an inner circumference of the mounting structure 1004), and the monolithic optical device 1002 can include one or more radial grooves of a corresponding geometry for mating with the radial ridges, thus providing a mounting interface 1006. The mounting structure 1004 can further include one or more vibration isolators 1008.

Example Embodiments of Optothermal Management

Additional aspects of the present disclosure relate to optothermal management for overcoming technical challenges related to large aperture monolithic optical devices. A system thermo-optical performance (STOP) analysis was completed using Finite Element Analysis (FEA) and custom ray tracing code to quantify the optical effects of thermal gradients within the monolith. This analysis supported the hypothesis that management of passive radiative and conductive boundary conditions can achieve diffraction limited performance while in LEO, and due to its simplicity, this is a good approach. Although monoliths are inherently insensitive to absolute temperature over a broad range (>50K), they can suffer from image quality degradation due to optical path difference incurred through temperature dependent index of refraction driven which drive temperature inhomogeneity within the bulk glass. In general, these gradients, should be held to <1K. The analysis supports a passive approach can achieve this requirement.

Monolith optical performance can be diffraction limited over a wide range of temperature (±25K) due to the small rate of thermal expansion of fused silica (0.5 ppm/K) and due to its minors remaining confocal as a function of temperature. However, monoliths can be affected by temperature inhomogeneity due to temperature dependent index of refraction, known as dndT. FEA models predict temperature homogeneity and ray trace codes to simulate its effects on optical performance. These computational tools were validated by analyzing simple analytical limiting cases. A hypothesis is that that passive thermal management via tuning of spatially dependent conductive and radiative boundary conditions can be sufficient to achieve diffraction limited performance. In some examples, a passive approach is preferred due to its simplicity by eliminating failure prone and costly active controls (e.g., heaters). To support the hypothesis, targeted experiments can be employed which aim to directly measure monolith temperature homogeneity within a simulated space environment using a thermal surrogate monolith instrumented in three-dimension fabricated from a suitable material. Acrylic is one candidate surrogate material because of its low cost, matched thermal diffusivity coefficient, and ease of integrating temperature sensors within its bulk. Experiments using this thermal simulant are an essential tool needed to validate our FEA codes and to show the housing under static and transient thermal loads.

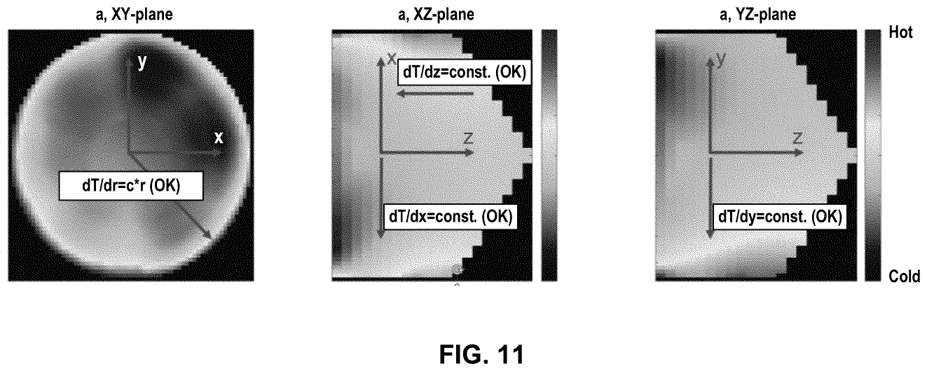

Monolith thermal management may have temperature homogeneity within the bulk glass on the order of 1K due to temperature dependent index of refraction induced optical path difference (OPD). This effect is a direct thermal analog to stress-induced OPD. Such changes in the bulk index of refraction integrate over the long optical path lengths through the monolith. For a 50-cm monolith, this constitutes 1-meter of physical length, 1.5 m of optical path length, or 3 million wavelengths in the visible spectrum. A difference of 1 part per 3 million may degrade optical performance to below the diffraction limit. For context, dndT for fused silica is −13 ppm/K, and OPD is as dndT*ΔT*L, where ΔT is the temperature change, and L is the path over which the optical path difference is referenced. An OPD on the order of few wavelengths uniformly across the aperture is referred to as “piston” in optics jargon, and has no consequence on optical performance. Similarly, OPD up to a few wavelengths that has a linear dependence along the wavefront is known as tilt, and has X and Y components, which results in an almost always benign shift in the image, and no change in image quality. Additionally, a parabolic wavefront error shape can be focus compensated simply by translating the focal plane by a small amount, without any loss of image quality up to several wavelengths. Consequently, OPD terms which have a piston, tilt or defocus shapes can be tolerated to moderate magnitude, especially if a focus mechanism is employed. The below and FIG. 11 summarize which temperature driven spatial dependent terms are sensitive and which are insensitive. Thermal effects are driven by solid-state heat diffusion which drives spatially slowly varying temperature changes. Temperature changes which vary slowly suggest low temperature sensitivity. The significant mass and heat capacity of a 50-cm monolith means thermal gradients will change slowly with time. Transient FEA analysis would permit study of the temporal component. Up to magnitude limits, insensitive components can be focus compensated or are inconsequential on image quality. Sensitive components degrade image quality in excessive magnitudes and should be held to less than a 0.25 wavelength RMS OPD.

Temperature Dependencies of Lesser Consequence:
2^{nd} order (parabolic) in radius=Moderate sensitivity
Linear in x or y=Low sensitivity
Linear in z=insensitive, Nonlinear in z=Low sensitivity

For moderate magnitudes, the above can be compensated by focal plane shift (re-focusing).

Harmful Temperature Spatial Dependencies:
Asymmetric in XY=High sensitivity
Non parabolic dependence in radius

Thermal gradients are driven at the boundary of the glass via heat transfer, either conductively or radiatively in the vacuum of space (i.e., no convection). Heat loss along the optical axis manifests as a piston, and as previously described has no consequence on performance and can be negated. Important boundary conditions are therefore those which drive non-piston, non-tilt, and non-parabolic terms. Such gradients are controlled at the surface boundaries of the monolith to drive temperature gradients in the plane of the aperture, perpendicular to the telescope optical axis. There are two such boundaries that can be broadly categorized as the outer cylinder of the telescope and the front and rear of the telescope. The outer cylinder of the telescope is symmetric with the optical axis. Therefore, any loss or gain of heat on the outer cylinder will develop temperature dependencies with axial symmetry. Owning to the heat diffusion equation, the radial boundary conditions largely have parabolic spatial dependence. Such parabolic terms can be corrected by a focus mechanism (if one is employed) so long as the magnitude is less than a few wavelengths. Radiative loss or gain of energy via emission or absorption of infrared (IR) radiation at the aperture can heat or cool the plano face of the telescope. When heat loss and gain on the monoliths plano face are not in equal magnitude, the telescope is not in thermodynamic equilibrium with the environment. This condition drives axially symmetric and non-axial symmetric temperature gradients. When these terms take on piston, tilt, or small magnitude parabolic terms (assuming focus mechanism), they are inconsequential. Conversely, any axial symmetric temperature terms which are different from these (not piston, tilt, nor parabolic), or if any terms are non-axially symmetric, these boundary conditions will degrade image quality. Based on this careful management of theses boundaries can avoid deleterious temperature gradient terms. Passive management of radiative and conductive parameters at the relevant boundaries can provide the required temperature homogeneity to meet diffraction limited performance in orbit.

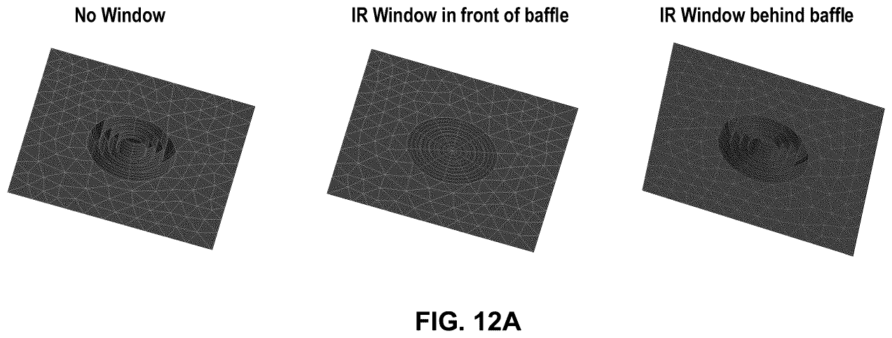

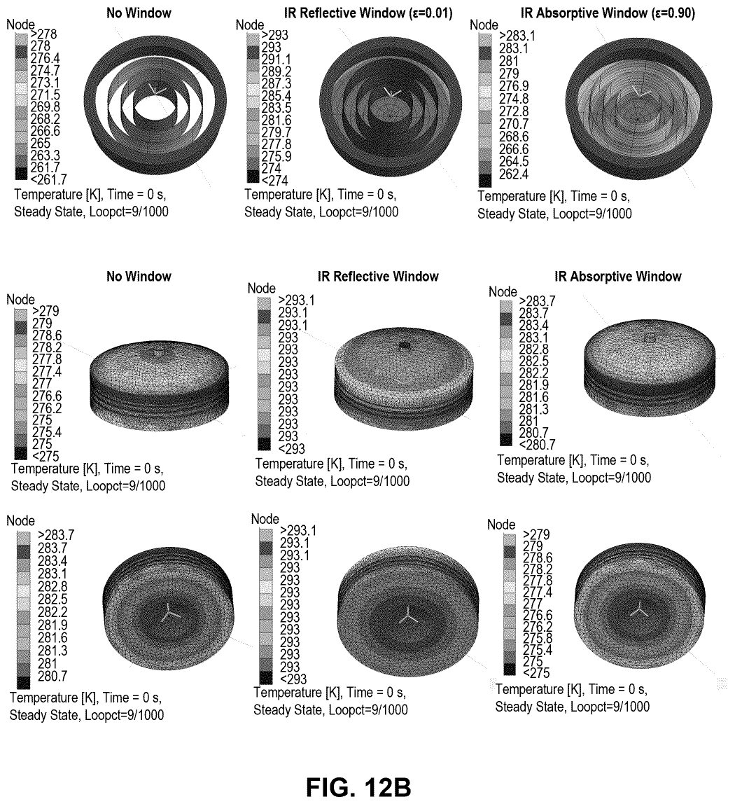

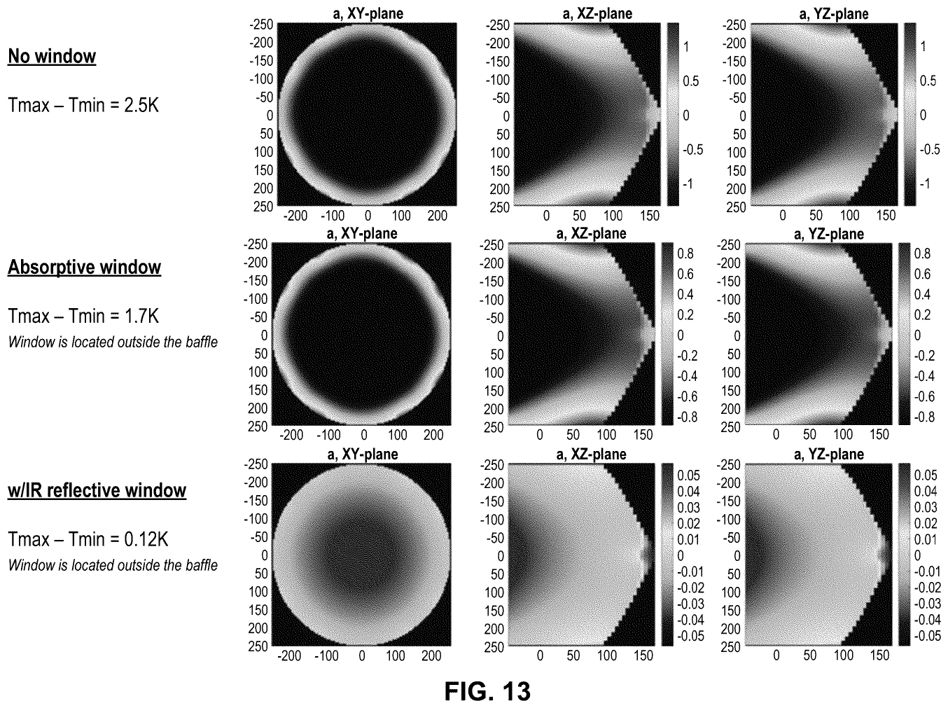

FIGS. 12A-12B summarize the thermal FEA of a 50-cm monolith, mounted internally within a satellite, in a sun-synchronous low-Earth orbit using thermal desktop software. Controlling the temperature gradient in an internally mounted configuration is more thermally challenging due to mismatch between the relatively warm interior of the spacecraft and the cold (3K) radiative background of deep space, which drives heat loss out of the telescope aperture and temperature gradients as described previously. Three cases were analyzed where a window placed adjacent to the optic's aperture: 1) no window, 2) an IR reflective window, and 3) an IR absorptive window. The windows may be placed in front of or behind the optic's aperture, or along an optical path through the optic's aperture. A tested hypothesis is determining if mitigation the deleterious effects of thermal gradients on image quality due heat loss out of the telescope aperture by holding the telescope in thermal dynamic equilibrium with its environment to minimize thermal gradients with the bulk glass. The nominal control case (no window) predicted a 2.5K temperature difference (Tmax−Tmin). An absorptive window reduced this temperature difference by radiating more heat back into the telescope that was lost. The IR reflective window all but eliminated temperature differences across the monolith aperture, reducing Tmax−Tmin to just 0.12K, as indicated by FIG. 13. The IR reflective window provides dramatically superior temperature homogeneity, suggesting that the mitigation of heat loss out of the aperture would mitigate a significant mechanism driving thermal gradients.

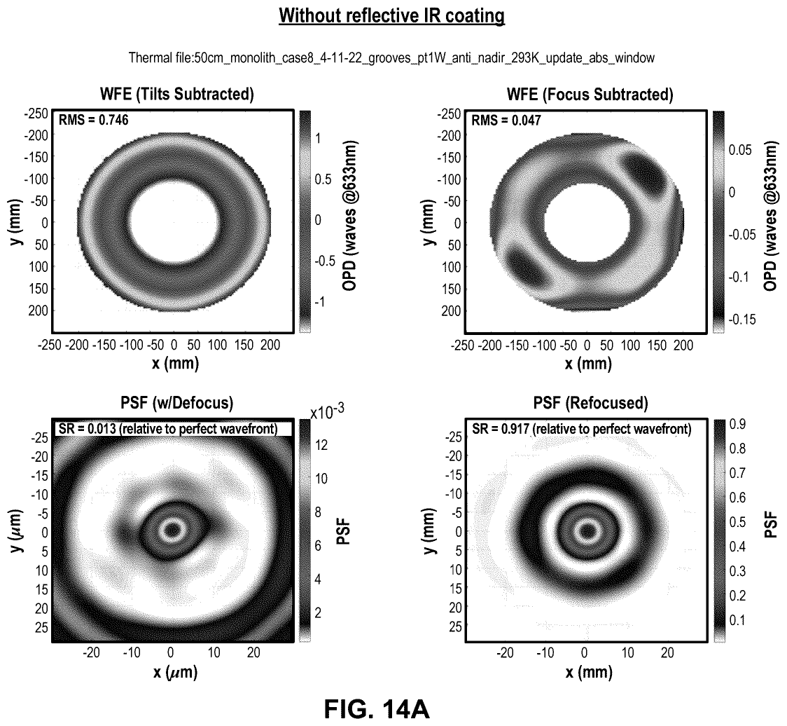

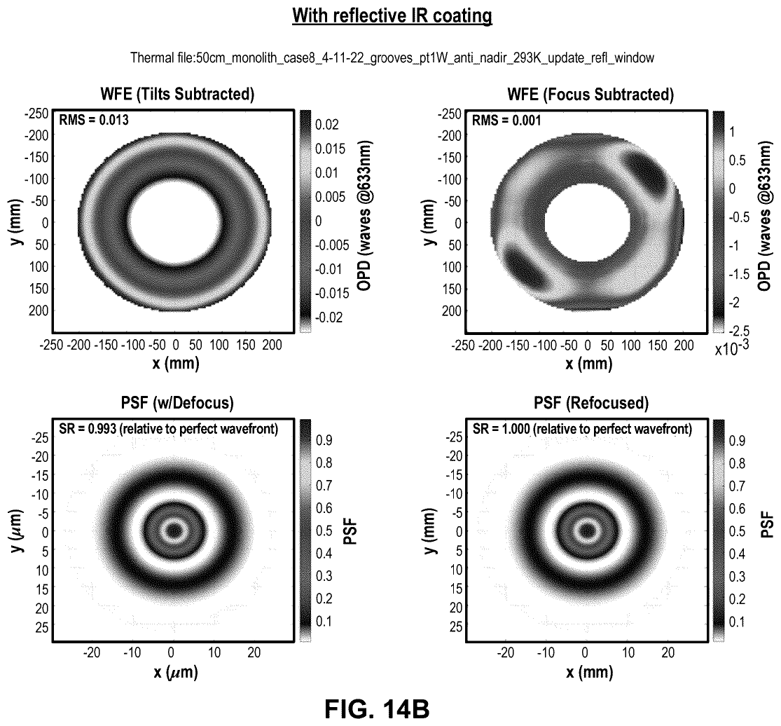

FIGS. 14A-14B show the optical ray trace analysis which integrates the OPD within the optic's pupil along thousands of ray paths sampled across the aperture. These data are then post-processed to calculate the RMS wavefront error and Strehl ratio of the point spread function (PSF). For most imaging applications, an RMS wavefront error of under 0.070 waves is generally considered diffraction limited, while a Strehl ratio of >0.8 is likewise considered diffraction limited.

FIG. 14A specifically represents the optical performance of the IR absorptive window, and FIG. 14B specifically represents the optical performance of the IR reflective window. The top plots in each of FIGS. 14A and 14B are the wavefront error expressed as optical path difference for 633 nm wavelength light, and the bottom plots in each of FIGS. 14A and 14B shows the point-spread function resulting from the wavefronts. Both metrics are presented with only piston and tilt subtracted (respective left sides of FIGS. 14A and 14B) and with piston, tilts, and focus subtracted (respective right sides of FIGS. 14A and 14B). Both cases show diffraction limited performance (near perfect or ideal image quality). The IR reflective window nearly fully mitigates any thermal gradient effects on image quality, predicting an RMS wavefront error of 0.001 waves and a Strehl ratio of 1.000, essentially perfect. Note these results assumes idealized conditions and does include other thermal or non-thermal effects. Therefore, FIGS. 14A-14B also suggest that the IR reflective window was found to substantially enhance the optical performance of the monolith within the simulated thermal environment.
In general, monolithic telescopes are insensitive to absolute temperature.
However, homogeneous temperature is needed to avoid accumulating optical path difference through the silica material due to temperature dependent index of refraction (dndT).
Through high fidelity FEA and ray trace modeling, it is shown that passive control of thermal boundary conditions provides the required monolith temperature homogeneity to deliver diffraction limited performance in orbit.
Axial symmetric parabolic temperature variation of 2° C. can be compensated for via refocusing.

Thus, in some embodiments, a monolithic optical system comprises an IR reflective window for passive optothermal management to enable diffraction-limited performance. In some embodiments, the IR reflective window is composed of or comprises an indium tin oxide (ITO) coating, a dielectric film, and/or the like configured for IR reflectance. In some embodiments, passive optothermal management features such as the IR reflective window can be combined with active management features such as actively-controlled heaters.

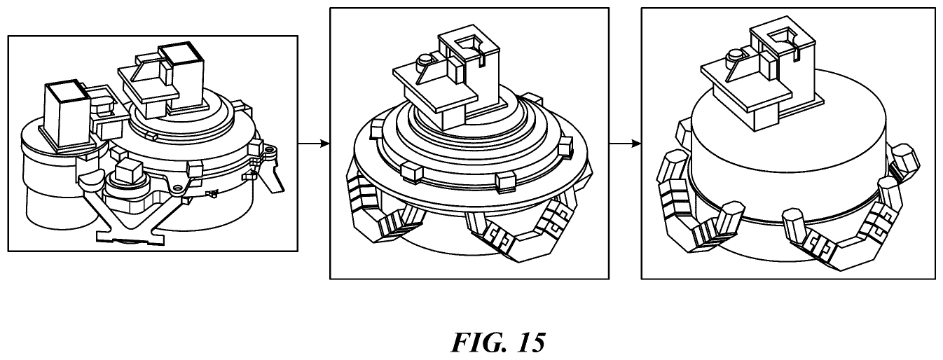

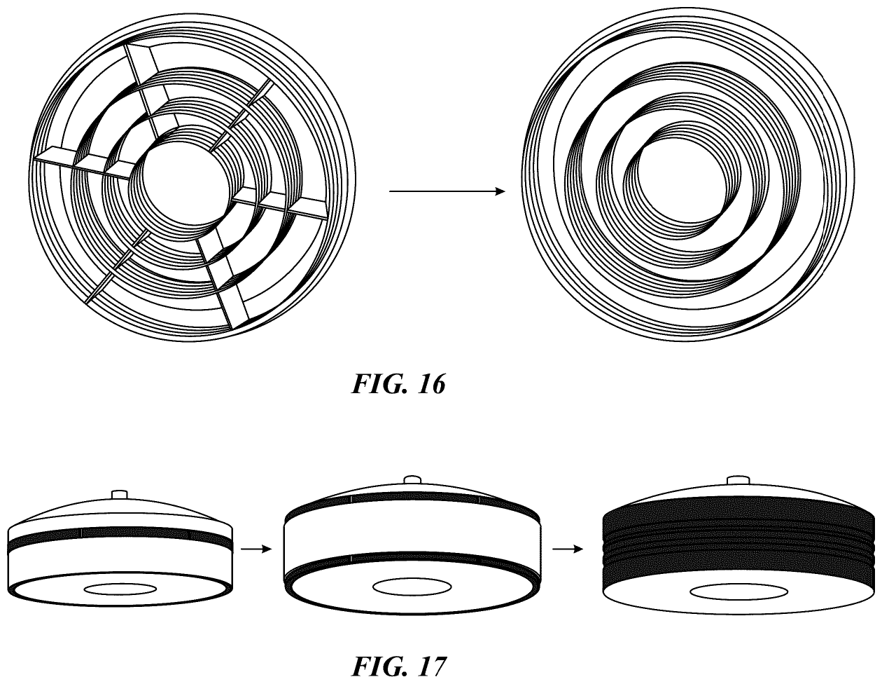

Other example means for passive optothermal management relate to bus configuration, baffle configuration, and conduction path. FIG. 15 depicts an evolution of a bus or mounting structure for a monolithic optical device to improve passive optothermal management of the monolithic optical device. In particular, thermal homogeneity is improved when the monolithic optical system is symmetric (e.g., axially). To achieve symmetry for thermal homogeneity, the monolithic optic is located centrally within the mounting structure, and external structure components can be removed or rearranged. FIG. 16 depicts an evolution of a baffle configuration where radial support pieces are removed while ringed vanes are kept, to improve thermal homogeneity and optical performance of a monolithic optical system. FIG. 17 demonstrates that thermal conductivity can be preserved when implementing the grooved mounting interface, in order to reduce significant effects on the thermal profile. In some embodiments, these example means for passive optothermal management may be implemented in combination with the IR reflective window.

Some preferred embodiments of the present disclosure implement the following solutions.

1. An optical mounting apparatus, comprising: a mounting structure including a plurality of segments that are configured to surround a circumferential area of a monolithic optical device and to hold the monolithic optical device in place, wherein each of the plurality of segments includes a ridged or a grooved interface surface to couple the mounting structure to one or more corresponding grooves or ridges in a surface of the monolithic optical device; and an elastomeric material confined between the ridged or grooved interface surface of the mounting structure and the one or more corresponding grooves or ridges in the surface of the monolithic optical device.

2. The optical mounting apparatus of solution 1, wherein the mounting structure excludes flanges or sections that protrude beyond the circumferential area of a monolithic optical device.

3. The optical mounting apparatus of solution 1, wherein each of the plurality of segments includes two or more ridges having a first elliptical shape that are configured to interface with two or more corresponding grooves in the surface of the monolithic optical device having a second elliptical shape.

4. The optical mounting apparatus of solution 3, wherein the first elliptical shape and the second elliptical shape are the same elliptical shape.

5. The optical mounting apparatus of solution 1, wherein each of the plurality of segments includes two or more ridges having a first sinusoidal shape that are configured to interface with two or more corresponding grooves in the surface of the monolithic optical device having a second sinusoidal shape.

6. The optical mounting apparatus of solution 1, wherein each of the plurality of segments includes two or more ridges having a first square or rectangular shape that are configured to interface with two or more corresponding grooves in the surface of the monolithic optical device having a second square or rectangular shape.

7. The optical mounting apparatus of solution 1, wherein the plurality of segments comprise between two and eight segments.

8. The optical mounting apparatus of solution 7, wherein the plurality of segments are held together with bolts that after tightening provide a predetermined pre-load compression force on the monolithic optical device.

9. The optical mounting apparatus of solution 1, further comprising: a plurality of vibration isolators coupled to the mounting structure and configured to isolate the mounting structure and the monolithic optical device from vibrations associated another component.

10. The optical mounting apparatus of solution 1, wherein the optical mounting apparatus comprises a carbon fiber composite material.

11. The optical mounting apparatus of solution 1, wherein the optical mounting apparatus is configured to exert 100 to 300 pounds of compression force on the monolithic optical device.

12. The optical mounting apparatus of solution 1, wherein the monolithic optical device is configured to hold in place the monolithic optical device that has a 50 cm diameter.

13. The optical mounting apparatus of solution 1, wherein:
the optical mounting apparatus is cylindrically symmetric,
the ridged or grooved interface surfaces of the plurality of segments of the mounting structure are configured to allow a uniformly distributed preload pressure to be applied onto the monolithic optical device.

14. The optical mounting apparatus of solution 1, wherein the ridged or grooved interface surfaces of the plurality of segments of the mounting structure when mated with the one or more corresponding grooves or ridges in the surface of the monolithic optical device produce a stable configuration that allows launch of an optical system that includes the optical mounting apparatus and the monolithic optical device in any launch orientation into outer space.

15. The optical mounting apparatus of solution 1, wherein the ridged or grooved interface surfaces of the plurality of segments of the mounting structure includes a single groove or ridge configured to interface with a corresponding single ridge or groove in the surface of the monolithic optical device, and wherein a location of the ridge or groove is selected to be aligned with a center of mass of the monolithic optical device.

16. The optical mounting apparatus of solution 1, wherein the elastomeric material is positioned to cover the entire circumferential area of the monolithic optical device that is confined within the plurality of segments of the mounting structure.

17. The optical mounting apparatus of solution 1, wherein the monolithic optical device is part of a spaceborne Cassegrain telescope.

18. The optical mounting apparatus of solution 1, wherein the elastomeric material comprises Viton or another fluoroelastomer material.

19. A method of mounting a monolithic optical device, comprising: holding in position, by a mounting structure, the monolithic optical device; coupling the mounting structure to the monolithic optical device via a ridged or grooved interface surface on the mounting structure structured to couple to corresponding grooves or ridges in a surface of the monolithic optical device; and confining an elastomeric material between the ridged or grooved interface surface of the mounting structure and the corresponding grooves or ridges in the surface of the monolithic optical device.

20. The method of mounting the monolithic optical device of solution 18, further comprising: coupling a plurality of vibration isolators to the mounting structure configured to isolate vibration from a spacecraft from the mounting structure and monolithic optical device.

21. The method of mounting the monolithic optical device of solution 18, wherein ridges of ridged interface surface of the mounting structure have a first elliptical shape, and wherein the compatible grooves in the surface of the monolithic optical device have a second elliptical shape.

22. An optical mounting apparatus, comprising: a mounting structure including a plurality of segments that are configured to surround a circumferential area of an optical device and to hold the optical device in place, wherein each of the plurality of segments includes a ridged or a grooved interface surface to couple the mounting structure to one or more corresponding grooves or ridges in a surface of the optical device; and an elastomeric material confined between the ridged or grooved interface surface of the mounting structure and the one or more corresponding grooves or ridges in the surface of the optical device.

23. The optical mounting apparatus of solution 22, wherein the optical device is a monolithic optical component.

24. The optical mounting apparatus of solution 22, wherein the mounting structure excludes flanges or sections that protrude beyond the circumferential area of the optical device.

25. The optical mounting apparatus of solution 22, wherein each of the plurality of segments includes two or more ridges having a first elliptical cross-sectional shape that are configured to interface with two or more corresponding grooves in the surface of the optical device having a second elliptical cross-sectional shape.

26. The optical mounting apparatus of solution 25, wherein the first elliptical cross-sectional shape and the second elliptical shape are the same elliptical cross-sectional shape.

27. The optical mounting apparatus of solution 22, wherein each of the plurality of segments includes two or more ridges having a first sinusoidal cross-sectional shape that are configured to interface with two or more corresponding grooves in the surface of the optical device having a second sinusoidal cross-sectional shape.

28. The optical mounting apparatus of solution 22, wherein each of the plurality of segments includes two or more ridges having a first rectangular cross-sectional shape that are configured to interface with two or more corresponding grooves in the surface of the optical device having a second rectangular cross-sectional shape.

29. The optical mounting apparatus of solution 22, wherein each of the plurality of segments includes two or more ridges having a first trapezoidal cross-sectional shape that are configured to interface with two or more corresponding grooves in the surface of the optical device having a second trapezoidal cross-sectional shape.

30. The optical mounting apparatus of solution 22, wherein each of the plurality of segments includes a ridge having an angled cross-sectional shape with at least one straight edge for interfacing with a corresponding groove in the surface of the monolithic optical device having a second angled cross-sectional shape with at least one straight edge.

31. The optical mounting apparatus of solution 22, wherein the plurality of segments comprise between two and eight segments.

32. The optical mounting apparatus of solution 31, wherein the plurality of segments are held together with bolts that after tightening provide a predetermined pre-load compression force on the optical device.

33. The optical mounting apparatus of solution 22, further comprising:
a plurality of vibration isolators coupled to the mounting structure and configured to isolate the mounting structure and the optical device from vibrations associated another component.

34. The optical mounting apparatus of solution 22, wherein the optical mounting apparatus comprises a carbon fiber composite material.

35. The optical mounting apparatus of solution 22, wherein the optical mounting apparatus is configured to exert 100 to 300 pounds of compression force on the optical device.

36. The optical mounting apparatus of solution 22, wherein the mounting structure is configured to hold in place the optical device that has an aperture with at least a 50 cm diameter.

37. The optical mounting apparatus of solution 22, wherein: the optical mounting apparatus is cylindrically symmetric, and the ridged or grooved interface surfaces of the plurality of segments of the mounting structure are configured to allow a uniformly distributed preload pressure to be applied onto the optical device.

38. The optical mounting apparatus of solution 22, wherein the ridged or grooved interface surfaces of the plurality of segments of the mounting structure when mated with the one or more corresponding grooves or ridges in the surface of the monolithic optical device produce a stable configuration that allows launch of an optical system that includes the optical mounting apparatus and the optical device in any launch orientation.

39. The optical mounting apparatus of solution 22, wherein the ridged or grooved interface surfaces of the plurality of segments of the mounting structure includes a single groove or ridge configured to interface with a corresponding single ridge or groove in the surface of the optical device, and wherein a location of the ridge or groove is selected to be aligned with a center of mass of the optical device.

40. The optical mounting apparatus of solution 22, wherein the elastomeric material is positioned to cover an entire circumferential area of the optical device that is confined within the plurality of segments of the mounting structure.

41. The optical mounting apparatus of solution 22, wherein the optical device is a monolithic lens that is part of a spaceborne Cassegrain telescope.

42. The optical mounting apparatus of solution 22, wherein the elastomeric material comprises Viton or another fluoroelastomer material.

43. The optical mounting apparatus of solution 22, wherein the optical mounting apparatus is part of a spaceborne optical system configured to launch into air, wherein the spaceborne optical system is configured to homogenize a temperature-dependent index of refraction for the optical device being held by the optical mounting apparatus.

44. The optical mounting apparatus of solution 43, comprising a focus mechanism configured to correct for optical path differences occurring in the optical device from temperature gradients.

45. The optical mounting apparatus of solution 43, wherein the optical mounting apparatus is coupled to one or more actively-controlled heaters of the spaceborne optical system that are operable to homogenize the temperature-dependent index of refraction for the optical device.

46. The optical mounting apparatus of solution 43, wherein the optical mounting apparatus is configured to hold the optical device according to an axial symmetry of the optical device to contribute to homogenizing the temperature-dependent index of refraction for the optical device.

47. The optical mounting apparatus of solution 43, wherein the optical device being held by the optical mounting apparatus comprises an infrared reflective window that is configured to minimize temperature gradients experienced by the optical device to homogenize the temperature-dependent index of refraction.

48. The optical mounting apparatus of solution 43, wherein a combined weight of the optical mounting apparatus and the optical device being launched into the air is greater than or equal to 30 kg.

49. An optical system comprising: an optical device having grooves or ridges defined along a circumferential surface; a mounting structure configured to secure the optical device via a ridged or a grooved interface surface of the mounting structure corresponding to the grooves or ridges of the optical device; and an infrared reflective window positioned along an optical path through an aperture of the optical device and configured to increase a thermal homogeneity within the optical device.

50. The optical system of claim 49, wherein the optical device comprises a monolithic body, and wherein the infrared reflective window is configured to increase the thermal homogeneity throughout the monolithic body.

51. The optical system of claim 49, further comprising: an actively-controlled heater operable to cool or heat at least a portion of the optical device.

52. The optical system of claim 49, wherein the optical device is configured for diffraction-limited performance based on (i) the mounting structure managing a stress-dependent index of refraction, and (ii) the infrared reflective window managing a temperature-dependent index of refraction.

53. The optical system of claim 59, wherein the optical device comprises an aperture having a diameter greater than 18 cm.

Although a few variations have been described in detail above, other modifications or additions are possible. In particular, further features and/or variations may be provided in addition to those set forth herein. Moreover, the example embodiments described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

Only a few implementations and examples are described and other implementations, enhancements and variations can be made based on what is described and illustrated in this patent document. Moreover, the separation of various system components in the embodiments described in this patent document should not be understood as requiring such separation in all embodiments.

What is claimed is:

1. An optical mounting apparatus, comprising:
a mounting structure including a plurality of segments that are configured to surround a circumferential area of an optical device and to hold the optical device in place, wherein each of the plurality of segments includes a ridged or a grooved interface surface to couple the mounting structure to one or more corresponding grooves or ridges in a surface of the optical device; and
an elastomeric material confined between the ridged or grooved interface surface of the mounting structure and the one or more corresponding grooves or ridges in the surface of the optical device.

2. The optical mounting apparatus of claim 1, wherein the optical device is a monolithic optical component.

3. The optical mounting apparatus of claim 1, wherein the mounting structure excludes flanges or sections that protrude beyond the circumferential area of the optical device.

4. The optical mounting apparatus of claim 1, wherein each of the plurality of segments includes two or more ridges having a first elliptical cross-sectional shape that are configured to interface with two or more corresponding grooves in the surface of the optical device having a second elliptical cross-sectional shape.

5. The optical mounting apparatus of claim 4, wherein the first elliptical cross-sectional shape and the second elliptical shape are the same elliptical cross-sectional shape.

6. The optical mounting apparatus of claim 1, wherein each of the plurality of segments includes two or more ridges having a first sinusoidal cross-sectional shape that are configured to interface with two or more corresponding grooves in the surface of the optical device having a second sinusoidal cross-sectional shape.

7. The optical mounting apparatus of claim 1, wherein each of the plurality of segments includes two or more ridges having a first rectangular cross-sectional shape that are configured to interface with two or more corresponding grooves in the surface of the optical device having a second rectangular cross-sectional shape.

8. The optical mounting apparatus of claim 1, wherein each of the plurality of segments includes two or more ridges having a first trapezoidal cross-sectional shape that are configured to interface with two or more corresponding grooves in the surface of the optical device having a second trapezoidal cross-sectional shape.

9. The optical mounting apparatus of claim 1, wherein each of the plurality of segments includes a ridge having an angled cross-sectional shape with at least one straight edge for interfacing with a corresponding groove in the surface of the monolithic optical device having a second angled cross-sectional shape with at least one straight edge.

10. The optical mounting apparatus of claim 1, wherein the plurality of segments comprises between two and eight segments.

11. The optical mounting apparatus of claim 10, wherein the plurality of segments are held together with bolts that after tightening provide a predetermined pre-load compression force on the optical device.

12. The optical mounting apparatus of claim 1, further comprising:
a plurality of vibration isolators coupled to the mounting structure and configured to isolate the mounting structure and the optical device from vibrations associated another component.

13. The optical mounting apparatus of claim 1, wherein the optical mounting apparatus comprises a carbon fiber composite material.

14. The optical mounting apparatus of claim 1, wherein the optical mounting apparatus is configured to exert 100 to 300 pounds of compression force on the optical device.

15. The optical mounting apparatus of claim 1, wherein the mounting structure is configured to hold in place the optical device that has an aperture with at least a 50 cm diameter.

16. The optical mounting apparatus of claim 1, wherein:
the optical mounting apparatus is cylindrically symmetric, and
the ridged or grooved interface surfaces of the plurality of segments of the mounting structure are configured to allow a uniformly distributed preload pressure to be applied onto the optical device.

17. The optical mounting apparatus of claim 1, wherein the ridged or grooved interface surfaces of the plurality of segments of the mounting structure when mated with the one or more corresponding grooves or ridges in the surface of the monolithic optical device produce a stable configuration that allows launch of an optical system that includes the optical mounting apparatus and the optical device in any launch orientation.

18. The optical mounting apparatus of claim 1, wherein the ridged or grooved interface surfaces of the plurality of segments of the mounting structure includes a single groove or ridge configured to interface with a corresponding single ridge or groove in the surface of the optical device, and wherein a location of the ridge or groove is selected to be aligned with a center of mass of the optical device.

19. The optical mounting apparatus of claim 1, wherein the elastomeric material is positioned to cover an entire circumferential area of the optical device that is confined within the plurality of segments of the mounting structure.

20. The optical mounting apparatus of claim 1, wherein the optical device is a monolithic lens that is part of a spaceborne Cassegrain telescope.

21. The optical mounting apparatus of claim 1, wherein the elastomeric material comprises Viton or another fluoroelastomer material.

22. The optical mounting apparatus of claim 1, wherein the optical mounting apparatus is part of a spaceborne optical system configured to launch into air, wherein the spaceborne optical system is configured to homogenize a temperature-dependent index of refraction for the optical device being held by the optical mounting apparatus.

23. The optical mounting apparatus of claim 22, comprising a focus mechanism configured to correct for optical path differences occurring in the optical device from temperature gradients.

24. The optical mounting apparatus of claim 22, wherein the optical mounting apparatus is coupled to one or more actively-controlled heaters of the spaceborne optical system that are operable to homogenize the temperature-dependent index of refraction for the optical device.

25. The optical mounting apparatus of claim 22, wherein the optical mounting apparatus is configured to hold the optical device according to an axial symmetry of the optical device to contribute to homogenizing the temperature-dependent index of refraction for the optical device.

26. The optical mounting apparatus of claim 22, wherein the optical device being held by the optical mounting apparatus comprises an infrared reflective window that is configured to minimize temperature gradients experienced by the optical device to homogenize the temperature-dependent index of refraction.

27. The optical mounting apparatus of claim 22, wherein a combined weight of the optical mounting apparatus and the optical device being launched into the air is greater than or equal to 30 kg.

28. A method of mounting a monolithic optical device, comprising:
holding in position, by a mounting structure, the monolithic optical device;
coupling the mounting structure to the monolithic optical device via a ridged or grooved interface surface on the mounting structure structured to couple to corresponding grooves or ridges in a surface of the monolithic optical device; and
confining an elastomeric material between the ridged or grooved interface surface of the mounting structure and the corresponding grooves or ridges in the surface of the monolithic optical device.

29. The method of mounting the monolithic optical device of claim 28, further comprising:
coupling a plurality of vibration isolators to the mounting structure configured to isolate vibration from a spacecraft from the mounting structure and monolithic optical device.

30. The method of mounting the monolithic optical device of claim 28, wherein ridges of ridged interface surface of the mounting structure have a first elliptical shape, and wherein compatible grooves in the surface of the monolithic optical device have a second elliptical shape.

31. An optical system comprising:
an optical device having grooves or ridges defined along a circumferential surface;
a mounting structure configured to secure the optical device via a ridged or a grooved interface surface of the mounting structure corresponding to the grooves or ridges of the optical device; and
an infrared reflective window positioned along an optical path through an aperture of the optical device and configured to increase a thermal homogeneity within the optical device.

32. The optical system of claim 31, wherein the optical device comprises a monolithic body, and wherein the infrared reflective window is configured to increase the thermal homogeneity throughout the monolithic body.

33. The optical system of claim 31, further comprising:
an actively-controlled heater operable to cool or heat at least a portion of the optical device.

34. The optical system of claim 31, wherein the optical device is configured for diffraction-limited performance based on (i) the mounting structure managing a stress-dependent index of refraction, and (ii) the infrared reflective window managing a temperature-dependent index of refraction.

35. The optical system of claim 31, wherein the optical device comprises an aperture having a diameter greater than 18 cm.
